(19) United States
(12) Patent Application Publication
(10) Pub. No.: US 2008/0305671 A1
(43) Pub. Date: Dec. 11, 2008

(54) Electrical Plug Connection

(76) Inventors: Antonio Lehner, Weiterstadt (DE); Philipp Mueller, Burstadt (DE); Waldemar Stabroth, Mommenheim (DE); Alexander Stokowski, Oetisheim (DE)

Correspondence Address: BARLEY SNYDER, LLC, 1000 WESTLAKES DRIVE, SUITE 275, BERWYN, PA, 19312, US

(21) Appl. No.: 12/128,914

(22) Filed: May 29, 2008

(30) Foreign Application Priority Data
Jun. 11, 2007 (DE) 102007026884.1

(51) Int. Cl. H01R 13/625

(52) U.S. Cl. 439/345

(57) ABSTRACT

An electrical plug connection includes a first plug member and a second plug member. The first plug member and the second plug member each have a plug recess module with a plug recess. At least one plug pin is arranged in the plug recesses of the plug recess modules that electrically connects the first plug member to the second plug member. The plug pin is fixed against removal from the plug recess of at least one of the plug recess modules.

### CROSS-REFERENCE TO RELATED APPLICATIONS

This application claims the benefit of the filing date under 35 U.S.C. §119(a)-(d) of German Patent Application No. DE 10 2007 026 884.1, filed Jun. 11, 2007.

### FIELD OF THE INVENTION

The present invention relates to an electrical plug connection comprising a first plug module electrically connected to a second plug module by a plug pin extending there between.

### BACKGROUND

Electrical plug connections comprising a female and a male plug member are known. The female plug member has plug recesses into which plug pins of the male plug member may be inserted. It often occurs that the electrical plug connection has to be fastened to a specific component. For this purpose, one of the plug members, for example the male plug member, has fastening structures. If the female plug member is plugged onto the male plug member, it is automatically held against the component.

It is, however, not possible to fasten the electrical plug connection via the female plug member to the component, as the female plug member does not have the fastening structures. Thus the electrical plug connection may only be used in a restricted manner.

### SUMMARY

The object of the present invention is to provide an electrical plug connection which may be adapted to different circumstances in the simplest possible manner with high flexibility.

This and other objects are achieved by an electrical plug connection comprising a first plug member and a second plug member. The first plug member and the second plug member each have a plug recess module with a plug recess. At least one plug pin is arranged in the plug recesses of the plug recess modules that electrically connects the first plug member to the second plug member. The plug pin is fixed against removal from the plug recess of at least one of the plug recess modules.

### BRIEF DESCRIPTION OF THE DRAWINGS

FIG. 1 is a perspective view of an electrical plug connection according to an embodiment of the invention in a plugged-together state,

FIG. 2 is a longitudinal sectional view of the electrical plug connection,

FIG. 3 is an exploded sectional view of a first plug member, a plug pin and a second plug member of the electrical plug connection,

FIG. 4 is a sectional view of the second plug member with the plug pin inserted therein,

FIG. 5 is a transverse longitudinal sectional view of the electrical plug connection in the plugged-together state,

FIG. 6 is a transverse longitudinal sectional view of the electrical plug connection with the first and second plug members moved apart by a first distance,

FIG. 7 is an exploded view of the first plug member,

FIG. 8 is a perspective view of the first plug member in the plugged-together state,

FIG. 9 is an exploded view of the second plug member the plug pins, and

FIG. 10 is a perspective view of the second plug member in the plugged-together state with the plug pins.

### DETAILED DESCRIPTION OF THE EMBODIMENT(S)

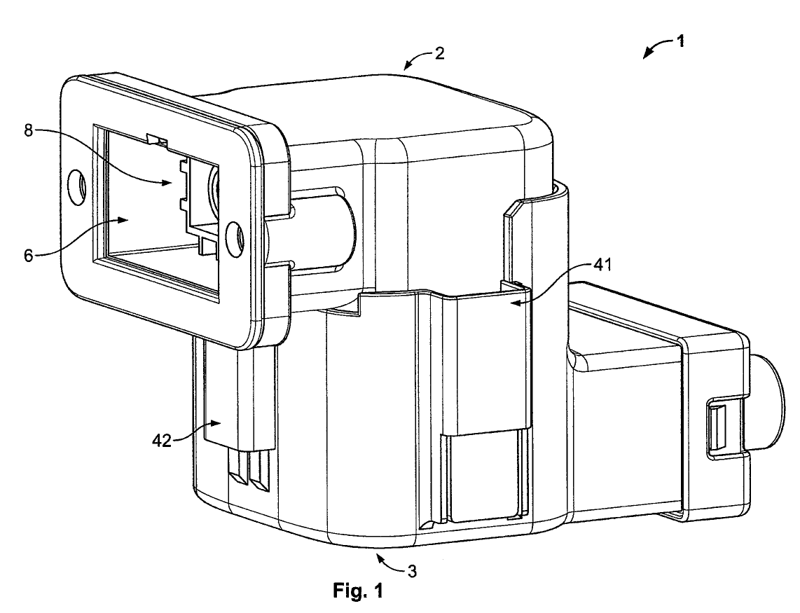

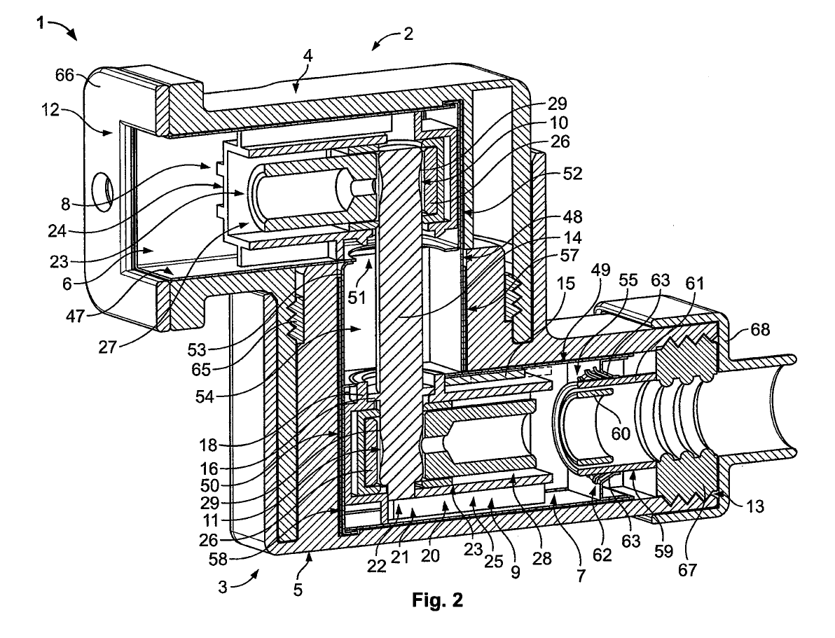

FIG. 1 is a perspective view of an electrical plug connection 1 according to an embodiment of the invention. The electrical plug connection 1 is shown in FIG. 2 in a longitudinal sectional view. The longitudinal sectional view is approximately centrally located through a first of two electrical paths. The electrical paths are of similar construction to one another, i.e. the aforementioned applies to one electrical path as for the other electrical path and/or the other side of the electrical plug connection 1.

As shown in FIG. 1, the electrical plug connection 1 has a first plug member 2 and a second plug member 3 which may be releasably plugged together. FIGS. 1 and 2 show the first plug member 2 and the second plug member 3 in a fully plugged-together state. The first and second plug members 2, 3 respectively have a housing 4, 5 in which at least one receiver space 6, 7 is formed. In each of the receiver spaces 6, 7 at least one plug recess module 8, 9 may be received which has at least one plug recess 10, 11 and may be connected to at least one supply line. In the present embodiment, the plug recess modules 8, 9 may be received in the same way in each of the receiver spaces 6, 7. In this manner, when assembling the first and second plug members 2, 3 it may be selected which one of the plug recess modules 8, 9 is used in which of the housings 4, 5. The plug recess modules 8, 9 are preferably able to be received releasably in the receiver spaces 6, 7. It is then possible to replace one or both of the plug recess modules 8, 9 retrospectively. In the present embodiment, the plug recess modules 8, 9 may be inserted into and removed from the receiver spaces 6, 7 through openings 12, 13 of the receiver spaces 6, 7 on a supply line side.

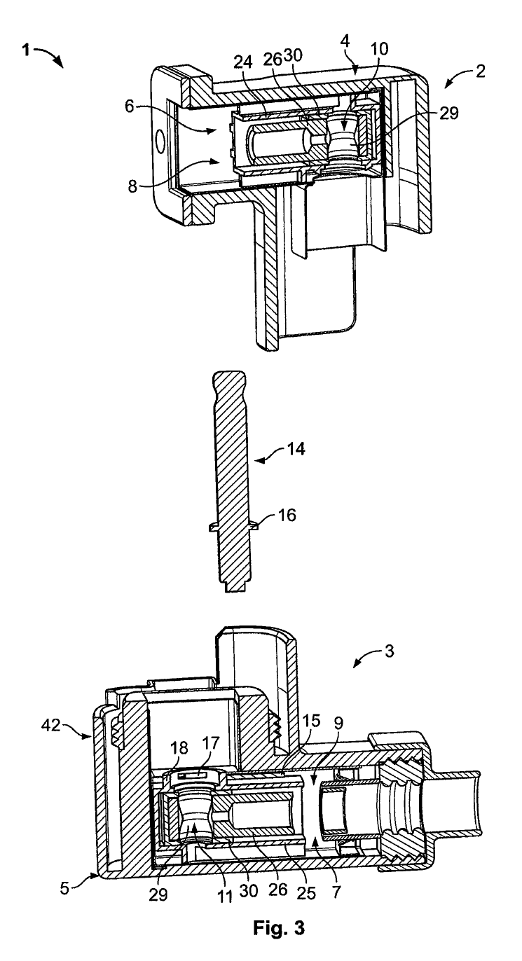

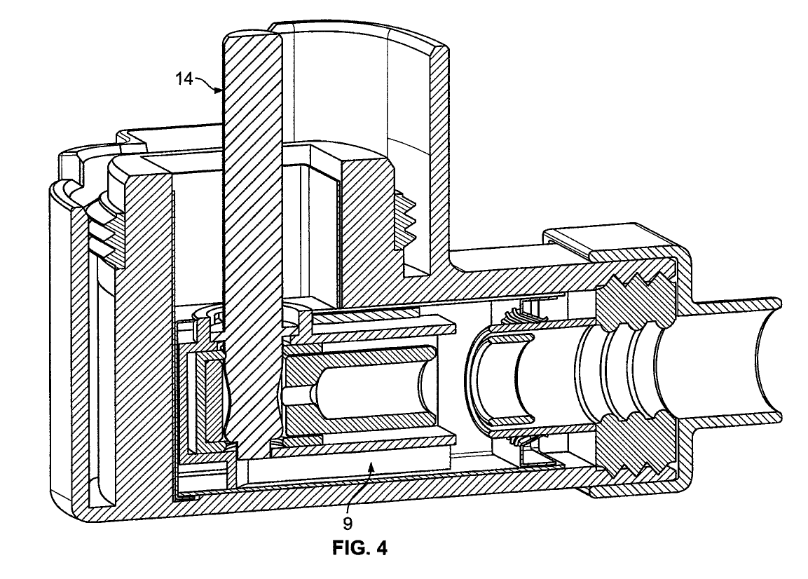

The electrical plug connection 1 also has a plug pin 14 which may be inserted into the plug recesses 10, 11 of the plug recess modules 8, 9. An electrical connection is created between the first and second plug members 2, 3 with the plug pin 14. The plug pin 14 may be fixed to the first plug member 2 and/or to the second plug member 3 against removal from the plug recesses 10, 11 of the first or second plug member 2, 3. It is clear therefrom that the first and second plug members 2, 3 are designed as female plug members. This is also illustrated in FIG. 3. Only via the fixing of the plug pin 14 to one of the first and second plug members 2, 3 do the first or second plug members 2, 3 and the plug pin 14 form a male plug arrangement as shown in FIG. 4. In the present embodiment, the plug pin 14 can be fixed to the plug recess module 9 of the second plug member 3.

For this purpose, a fixing element 15 is provided movably mounted on the plug recess module 9 and may be brought into positive engagement with the plug pin 14. The fixing element 15 may be displaced between a released position which is indicated in FIG. 2 by dotted lines, and a fixed position which is shown in FIG. 2 by solid lines. In the fixed position, the fixing element 15 engages behind a retaining profile 16 of the plug pin 14 extending transversely to the plug-in direction of the plug pin 14. In this embodiment of the invention, the retaining profile 16 is approximately of annular configuration and projects transversely to the plug-in direction of the plug pin 14 from the plug pin 14. The fixing element 15 has a fork-like portion 17 with which it partially encompasses the plug pin 14 and engages behind the retaining profile 16 thereof. The retaining profile 16 is used not only for fixing the plug pin 14 in the plug recess 11 but also defines its insertion depth into the plug recess 11. The retaining profile 16 is wider than a diameter of the plug recess 11 and comes to bear against the plug recess module 9 accordingly when inserting the plug pin 14.

The plug recess module 9 has a positioning profile 18 which surrounds the retaining profile 16 bearing against the plug recess module 9. When inserting the plug pin 14 into the plug recess 11, the positioning profile 18 ensures that the plug pin 14 is moved transversely to its plug-in direction into a predetermined position. In the inserted state, the positioning profile 18 supports the plug pin 14 transversely to its insertion direction. In the present embodiment of the invention, the positioning profile 18 is configured as a connecting piece. It is deeper than the dimension of the retaining profile 16 in the longitudinal direction of the plug pin 14 and has at least one guide 19 in which the fixing element 15 is movably mounted.

The plug recess 11 of the plug recess module 9 in which the plug pin 14 may be fixed is continuous. Thus, the plug pin 14 may be inserted into the plug recess module 9 until it reaches an opposing side 20 of the plug recess module 9. In the region of the opposing side 20, the plug recess module 8 has an opening 21, the internal width thereof corresponding to the external width of the guiding end 22 of the plug pin 14. The plug pin 14 is supported on the opposing side 20 of the plug recess module 9 transversely to its insertion direction into the plug recess 11. Thus, the plug pin 14 is well stabilized against transverse forces, which for example may act thereon during handling of the male plug arrangement.

In the embodiment shown in FIG. 2, fixing the plug pin 14 against removal from the plug recess 10 of the first plug member 2 is not required. Accordingly, in the first plug member 2 a plug recess module 8 is used to which the plug pin 14 is not able to be fixed against removal. The plug recess module 8 is, as a result, of more simple design, namely without fixing devices. It might also be possible in the first plug member 2 to use the same plug recess module 8 as in the second plug member 3. The fixing element 15 could be omitted. If, however, on the sides of the first plug member 2, the fixing element 15 is provided, even with the first plug member 2, a male plug arrangement may easily be configured, without having to install a further plug recess module. The fixing of the plug pin 14 to the plug recess module 9 of the second plug member 3 would have to be released and, conversely, the plug pin 14 would have to be inserted into the plug recess module 8 of the first plug member 2 and fixed there.

The plug recess modules 8, 9 of the embodiment shown in FIG. 2 have one respective contact module 23 as well as a contact module carrier 24, 25 carrying the contact module 23. The contact module carriers 24, 25 may be configured from a plastic material. The contact modules 23 are of the same construction and are respectively inserted into an interior 27, 28 of the contact module carrier 24, 25. Each of the contact modules 23 has a contact 26 made of electrically conductive material, a contact spring 29 made of electrically conductive material and a retainer 30. The contact springs 29 are respectively inserted into a recess of the contacts 26 and ensure a good contact between the plug pin 14 and the contact 26. The retainers 30 are pushed over the contacts 26 and retain the contact springs 29 in the contacts 26, for example when inserting and removing the plug pin 14. The contacts 26, the contact springs 29 and the retainers 30 respectively define a part of the plug recesses 10, 11 of the plug recess modules 8, 9. The contact module carrier 25 used in the second plug member 3 has the positioning profile 18 and, on the opposing side 20, the opening 21.

As emerges, for example, from FIG. 2, the insertion direction of the plug pin 14 extends into the plug recesses 10, 11 transversely to the longitudinal direction of the first and second plug members 2, 3, in particular transversely to the longitudinal direction of the plug recess modules 8, 9. As a result, the electrical plug connection 1 has a compact construction and low overall height in the plug-in direction. It is, however, also possible to provide at least one of the first and second plug members 2, 3 of which the longitudinal direction extends parallel to the insertion direction of the plug pin 14 into the plug recess or a plug member in which the longitudinal direction of the plug recess module extends parallel to the insertion direction of the plug pin 14 into the plug recess 10. Other alignments are also possible, in particular oblique alignments.

According to the invention, a male plug arrangement is formed with the second plug member 3 which is connected to an electrical consumer. In this manner, it is ensured that the plug pin 14 with the first and second plug members 2, 3 is disconnected from the power supply supplying the electric power consumer and in this regard, when the electrical plug connection 1 is disconnected, may be touched without danger. As a result, it is possible according to the invention to provide the plug pin 14 exposed, i.e. without a separate structural contact protection. This does not only simplify the construction but also allows a more compact construction than if a separate structural contact protection was required. The gain in compactness is plainly evident, in particular in the plug-in direction.

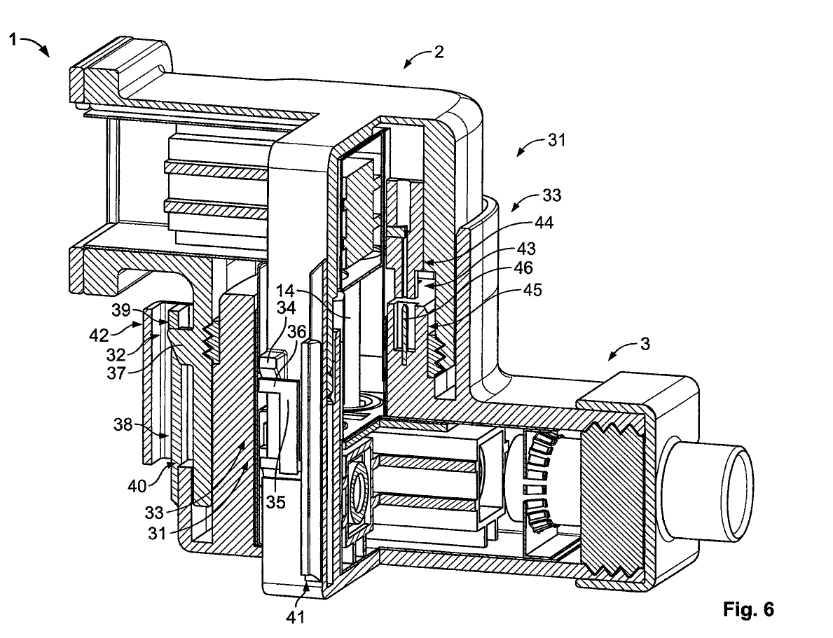

When disconnecting the first and second plug members 2, 3, in order to control the current flowing and/or an applied voltage, the electrical plug connection 1 may preferably have a two-stage lock 44 and/or a monitoring device, as shown in FIG. 6. The two-stage lock 44 has a first locking arrangement 31 which has to be unlocked for moving the first and second plug members 2, 3 apart by a first distance and a second locking arrangement 32 which has to be released for moving the first and second plug members 2, 3 further apart.

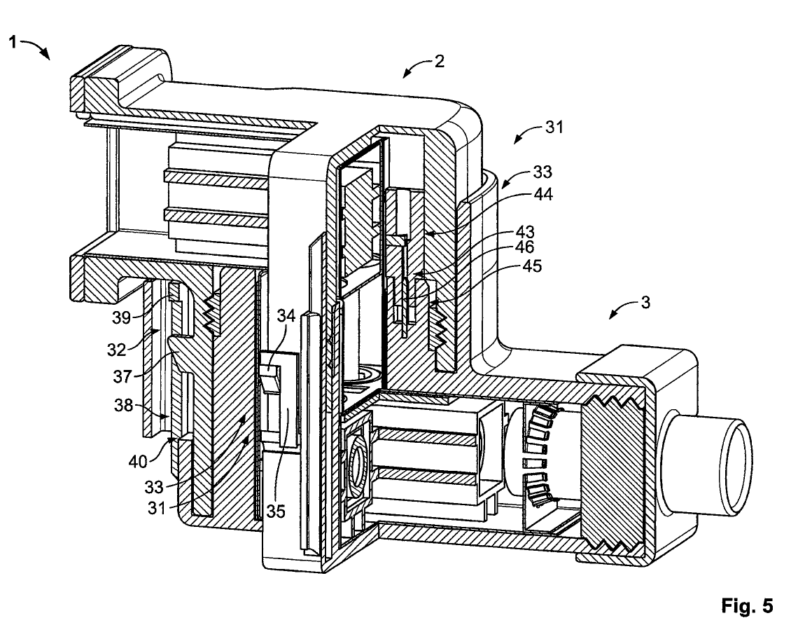

With the first locking arrangement 31, the first and second plug members 2, 3 are secured in a fully plugged-together state. The first locking arrangement 31 has two partial locks 33, 33 of the same construction which are provided on opposing sides of the electrical plug connection 1. In FIGS. 5 and 6, however, only one of these is shown. Each of the partial locks 33 has a latching lug 34 and a latching tab 35 which may be moved thereover with a corresponding latching counter profile 36. In the view of FIG. 5, in which the first and second plug members 2, 3 are located in the fully plugged-together state, the latching counter profile 36 engages behind the latching lug 34 and bears thereagainst so as to lock therewith.

In the view of FIG. 6, the first and second plug members 2, 3 are moved apart by the first distance, for which the latching counter profile 36 of the latching tab 35 has been moved in the disconnecting direction via the latching lug 34. The movement by the first distance is possible in spite of the second locking arrangement 32 being in a locked state. The second locking arrangement 32 has a latching lug 37 and a latching tab 38 with a corresponding latching counter profile 39. The latching lug 37, however, only comes into locking contact with the latching counter profile 36 as a result of moving by the first distance and may be moved up to that point in a recess 40 of the latching tab 38 relative thereto. Only by moving the latching counter profile 39 over the latching lug 37 is the locking contact released and a further moving apart of the first and second plug members 2, 3 made possible.

The two partial locks 33 and the second locking arrangement 32 are respectively arranged in a concealed manner behind a bracket-like wall 41, 42. This not only protects the first and second locking arrangements 31, 32 from damage but also makes access thereto more difficult, increasing in each case the time required for unlocking. The walls 41, 42 are only partially shown in FIGS. 5 and 6 and shown more clearly in FIGS. 1, 9 and 10. In the embodiment shown, the plug pin 14 is still in electrical contact with the first and second plug members 2, 3, if the first and second plug members 2, 3 are moved apart by the first distance. The monitoring device has a releasable electrical control contact arrangement 43 which in the fully plugged-together state of the first and second plug members 2, 3 is in a first electrically connected state and as a result of moving apart the first and second plug members 2, 3 by the first distance is brought into a second, different electrically connected state. The transition into the second connected state may even take place after a distance which is markedly shorter than the first distance.

The releasable electrical control contact arrangement 43 has a first monitoring plug 44 provided on the first plug member 2 and a second monitoring plug 45 provided on the second plug member 3. In the fully plugged-together state of the first and second plug members 2, 3, the first and second monitoring plugs 44, 45 are also fully plugged together, as is shown in FIG. 5. When the first and second plug members 2, 3 are moved apart, the first and second monitoring plugs 44, 45 are disconnected, as is shown in FIG. 6.

One of the monitoring plugs may be connected to a two-pole monitoring supply line which is connected to an evaluation device. The other monitoring plug may contain a short circuit element via which the two poles of the monitoring supply are short-circuited if the monitoring plugs are in the plugged-together state and are disconnected if the monitoring plugs are disconnected. In the present embodiment, the second monitoring plug 45 has the short-circuit element 46.

Via the disconnection of the first and second monitoring plug 44, 45 it is identified by means of the monitoring device that a disconnection of the first and second plug members 2, 3 may be deliberate. In order to avoid an electric arc when disconnecting the first and second plug members 2, 3, the electric power consumer is set to no load, for example via an interruption of the power supply to the electrical plug connection 1.

In spite of the no load state of the electric power consumer, the electrical plug connection 1 may still be live, for example a voltage may be applied which is maintained for a further period of time by capacitors of the electric power consumer. For releasing the second locking arrangement 32 a certain time is necessary, for example several seconds. Thus sufficient time is available to reduce an applied voltage. For example, the time required for releasing the second locking arrangement 32 may be sufficient for the voltage maintained by the capacitors of the electric power consumer to cease substantially on its own. Additionally or alternatively the voltage may be reduced by means of the monitoring device. It is also conceivable to ensure an automatic voltage reduction in at least one of the first and second plug members 2, 3 with electrical structural elements. Because of the reduction of the voltage it is possible to touch the plug pin 14 without danger, which is fixed to the second plug member 3 connected to the electric power consumer. Thus, the plug pins 14 may be provided exposed, i.e. without separate structural contact protection.

It is possible to dispense with the second locking arrangement 32, for example, if by the monitoring device and/or by the electrical elements in at least one of the first and second plug members 2, 3 an active voltage reduction is ensured. This is possible in particular with rapid reacting systems. Alternatively or additionally, it is possible to dispense with the releasable electrical control contact arrangement 43. For example, electrical structural elements and/or a control unit may be provided which when disconnecting the electrical contact between the first and second plug members 2, 3 eliminates the occurrence of an electric arc. Without a control contact arrangement, the electrical plug connection 1 may be of more compact configuration, for example in the plug-in direction.

If the releasable electrical control contact arrangement 43 is dispensed with, the electrical plug connection 1 may be configured such that the electrical connection between the first and second plug members 2, 3 is already interrupted after a movement apart by the first distance. Thus even more time for reducing voltages might be available. Thus, after passing the first distance, additional time is required until an operator actually begins to release the second locking arrangement 32.

In the present embodiment of the invention, the releasable electrical control contact arrangement 43 is provided in the interior of the electrical plug connection 1. It may also be provided externally on the electrical plug connection 1. It is also possible to provide the control contact arrangement separately from the first and/or the second plug member 2, 3. In particular with a separate control contact arrangement, further constructional space may be saved, for example in the plug-in direction of the first and second plug members 2, 3. A control contact arrangement provided separately or externally on the electrical plug connection 1 may by omitted if required. Thus it is possible to use the same plug connection in cases where a control contact arrangement is to be used and also in those cases in which said arrangement is to be dispensed with.

The electrical plug connection 1 and the control contact arrangement may be provided to control one another mechanically. In this case, there is a possibility that the first and second plug members 2, 3 of the electrical plug connection 1 are only able to be disconnected if the control contact arrangement is disconnected and the control contact arrangement is only able to be plugged together if the first and second plug members 2, 3 of the electrical plug connection 1 are plugged together. In this case, the control contact arrangement, for example, may be configured and/or act in the manner of a bolt. In particular when a bolt has to be moved transversely to the plug-in direction of the first and second plug members 2, 3, the electrical plug connection 1 may be configured more compactly in the plug-in direction.

Reference is made to FIG. 2. The first and second plug members 2, 3 form in the plugged-together state an electrically shielded interior. For this purpose, the receiver spaces 6, 7 of the first and second plug members 2, 3 are lined with first, second, third, and fourth electrically conductive shielding linings 47, 48, 49, 50. The receiver space 6 of the first plug member 2 extends substantially in the longitudinal direction of the first plug member 2 and is lined with a first shielding lining 47 in the form of a hollow body, which is adapted to the shape of the receiver space 6, is open in the region of the opening 12 on the supply line side, and is closed on the opposing side 20. In the longitudinal portion of the first shielding lining 47 which is associated with the plug recess 10 of the first plug member 2, the first shielding lining 47 has a through-hole 51 through which the plug pin 14 may be passed.

The first plug member 2 has a second shielding lining 48 which has a tongue 52 which is arranged between the closed end of the first shielding lining 47 and the relevant wall of the receiver space 6 and is in flush contact with the closed end of the first shielding lining 47. The second shielding lining 48 further has a hollow body portion 53 with a closed cross-sectional profile, which adjoins the tongue 52 and, surrounding the through-hole 51, bears against the first shielding lining 47. In this manner, the first and second shielding linings 47, 48 form a shield bent back at an angle.

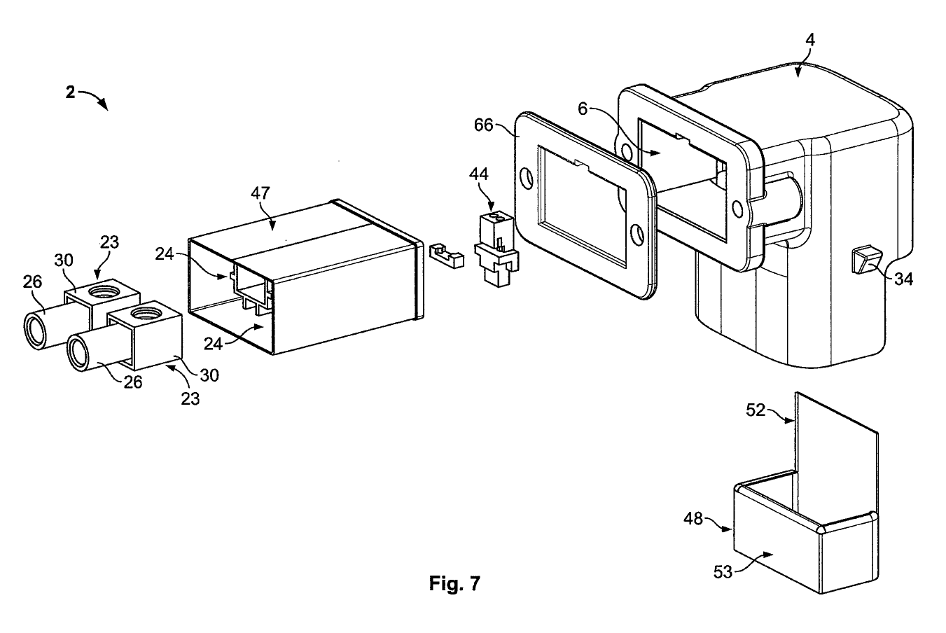

Concerning the construction of the second shielding lining 48, reference is additionally made to FIG. 7, which shows the first plug member 2 in an exploded view. As is revealed from FIG. 2, the receiver space 6 of the second plug member 3 is configured bent back at an angle. A first receiver space portion 54 is provided on the sides of the first plug member 2 and creates a connection to the receiver space 6 thereof. A second receiver space portion 55 is provided at an angle to the first receiver space portion 54 and receives the plug recess module 9.

In the second receiver space portion 55 a third shielding lining 49 is provided which is configured in the manner of a hollow body and is adapted to the shape of the second receiver space portion 55. The third shielding lining 49 is configured closed at one end opposing the opening 13 of the receiver space 7 on the supply line side and has, in the longitudinal portion which is associated with the plug recess 11, a through-opening 56 through which the plug pin 14 may be passed. The first receiver space portion 54 is lined by a fourth shielding lining 50, namely with a hollow body portion 57 which has a closed cross-sectional profile and open ends, the plug pin 14 being able to be passed therethrough. To the hollow body portion 57 is attached a connection piece 58 which has a U-shaped cross section and as a result lies flat against the third shielding lining 49 from the outside. Thus the third and fourth shielding lining 49, 50 also form a shield bent back at an angle. When plugging together the first and second plug members 2, 3, the hollow body portion 57 of the fourth shielding lining 50 and the hollow body portion 53 of the second shielding lining 48 are inserted into one another and as a result are brought into flush contact with one another as is revealed from FIG. 2.

The supply line, not shown, to the second plug member 3 is provided with a shielding arrangement, for example with a coaxial shield. The shielding of the second plug member 3 is able to be electrically connected to the shielding arrangement of the supply line. For this purpose, a crimp arrangement 59 is provided with step-like internal width adaptation. In the present embodiment, the crimp arrangement 59 is of two-part configuration and has a first crimp member 60 of a first internal width as well as a second crimp member 61 of a second internal width. The internal width of the first crimp member 60 corresponds approximately to the external width of the shielding arrangement of the supply line. The external width of the first crimp member 60 corresponds approximately to the internal width of the second crimp member 61, the first crimp member 60 being able to be inserted into the second crimp member 61. The thickness of a covering around the shielding arrangement of the supply line is compensated by the first crimp member 60. As a result of crimping, the first crimp member 60 is fixedly connected electrically to the shielding arrangement. The internal width of the second crimp member 61 corresponds approximately to the external width of the supply line. As a result of crimping, the second crimp member 61 is fixedly connected electrically to the first crimp member 60.

The connection of the crimp arrangement 59 to the third shielding lining 49 takes place by means of an adapter 62 provided on the third shielding lining 49. The adapter 62 has an opening 64 with a plurality of resilient spring legs 63. By means of the spring legs 63 the size of the opening 64 may be flexibly adapted to the size of the crimp arrangement 59 to be received. Additionally, the resilient pretensioning of the spring legs 63 ensures a good electrical contact between the adapter 62 and the crimp arrangement 59.

The first and second plug members 2, 3 are sealed. Between the first and second plug members 2, 3 a seal 65 is provided which is mounted on the second plug member 3. The opening 12 on the supply line side of the first plug member 2 is surrounded by a seal 66, which is brought into contact with the component to which the first plug member 2 is fastened. In the region of the opening 13 on the supply line side of the second plug member 3 a seal 67 is provided resting against the crimp arrangement 59 and/or the supply line. Additionally, a sealing cap 68 is pushed over the relevant end of the housing 5.

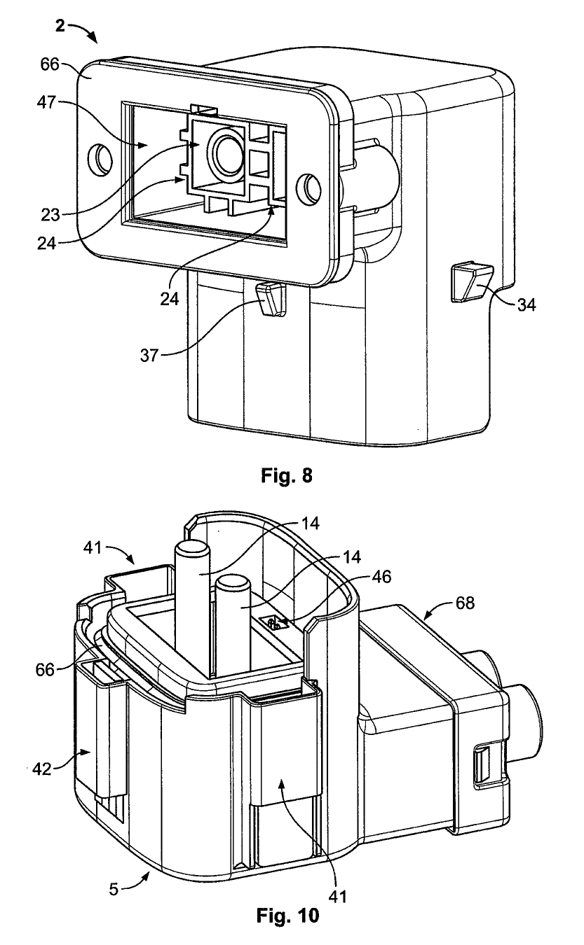

FIG. 7 shows an exploded view of the first plug member 2. It emerges therefrom that the receiver space 6 is a common receiver space for both electrical paths and the first and second shielding lining 47, 48 are adapted to this design. Moreover, it is revealed from FIG. 7 and from FIG. 8, which shows the first plug member 2 in the assembled state, that the contact module carriers 24 of both electrical paths are connected to one another and are configured as an integral arrangement.

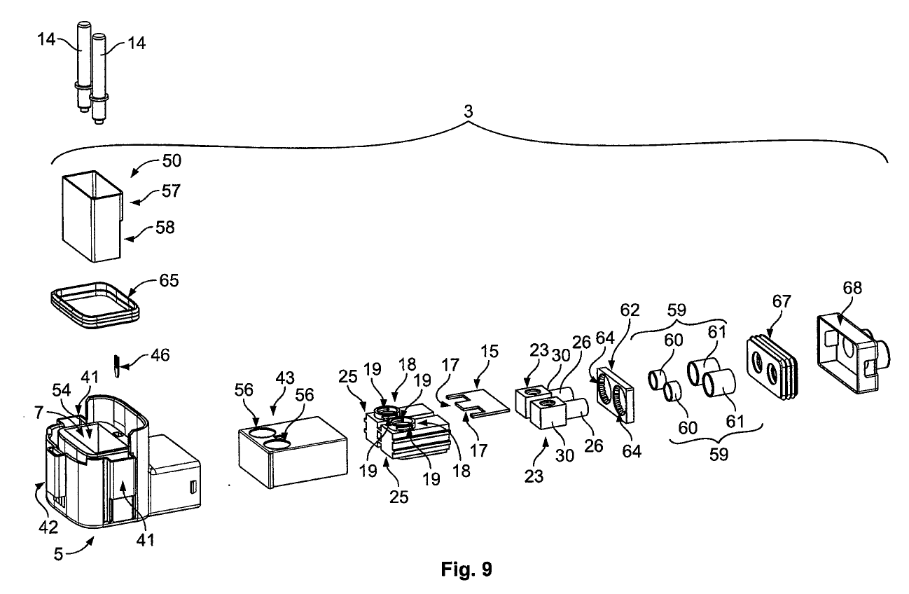

FIG. 9 shows the plug pins 14 for the two electrical paths as well as the second plug member 3 in an exploded view. It is clear therefrom that the receiver space 7 is a common receiver space 6 for both electrical paths, and that the third and fourth shielding linings 49, 50 are adapted to this design of the receiver space 7.

It is also shown that the contact module carriers 25 of the two electrical paths are connected to one another and are configured as an integral arrangement. Also, the fixing element 15 is an integral component for both electrical paths and has the fork-like portions 17.

It is further revealed from FIG. 9 that the guides 19 are notches configured on the positioning profiles 18, which guide the fork-like portions 17 of the fixing element 15 and through which the fork-like portions 17 are partially able to penetrate into the space enclosed by the positioning profiles 18, in order to engage behind the retaining profile 16 of the plug pin 14. The adapter 62 of the third shielding lining 49 is also an integral component which has a separate opening 64 for each electrical path.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. An electrical plug connection, comprising:
a first plug member and a second plug member, the first plug member and the second plug member each having a plug recess module with a plug recess; and
at least one plug pin arranged in the plug recesses of the plug recess modules that electrically connects the first plug member to the second plug member, the plug pin being fixed against removal from the plug recess of at least one of the plug recess modules.

2. The electrical plug connection of claim 1, wherein the plug pin is releasably fixed in the plug recess of at least one of the plug recess modules.

3. The electrical plug connection of claim 1, wherein each of the plug recess modules are releasably received in receiver spaces in the first and second plug members.

4. The electrical plug connection of claim 1, further comprising a fixing element that engages the plug pin to fix the plug pin in the plug recess.

5. The electrical plug connection of claim 4, wherein the fixing element at least partially encompass the plug pin.

6. The electrical plug connection of claim 4, wherein the plug pin includes a retaining profile that defines an insertion depth of the plug pin into the plug recess into which the plug pin is fixed.

7. The electrical plug connection of claim 6, wherein the fixing element engages the retaining profile of the plug pin.

8. The electrical plug connection of claim 6, wherein the plug recess module has a positioning profile that supports the retaining profile transversely to an insertion direction of the plug pin into the plug recess into which the plug pin is fixed.

9. The electrical plug connection of claim 8, wherein the fixing element is movably mounted on the positioning profile.

10. The electrical plug connection of claim 4, wherein the fixing element is movably mounted on the plug recess module of the plug recess into which the plug pin is fixed.

11. The electrical plug connection of claim 1, wherein a longitudinal direction of the first plug member extends transversely to an insertion direction of the plug pin into the plug recesses of the plug recess modules of the first and second plug members.

12. The electrical plug connection of claim 1, further comprising a monitoring device that determines when the first and second plug members are moved apart by a first distance.

13. The electrical plug connection of claim 12, wherein the first and second plug members are moved apart by the first distance without being mechanically disconnected from one another.

14. The electrical plug connection of claim 12, wherein the first and second plug members remain electrically connected when moved apart by the first distance.

15. The electrical plug connection of claim 12, wherein the monitoring device has a releasable electrical control contact arrangement that is in a first electrically connected state when the first and second plug members are in a plugged-together state and in a second electrically connected state when the first and second plug members are moved apart by the first distance which is different from the first electrically connected state.

16. The electrical plug connection of claim 15, wherein the releasable electrical control contact arrangement is a plug connection.

17. The electrical plug connection of claim 1, further comprising a two-stage lock that locks the first plug member to the second plug member, the two-stage lock has a first locking arrangement that prevents the first and second locking members from moving apart a first distance, the first and second plug members still being electrically and mechanically connected to each other at the first distance.

18. The electrical plug connection of claim 17, further comprising a second locking arrangement that prevents the first and second locking members from moving apart a distance farther than the first distance.

19. The electrical plug connection of claim 1, wherein the first and second plug members in a plugged-together state form an electrically shielded interior in which the plug recesses are arranged.

20. The electrical plug connection of claim 1, wherein at least one of the first and second plug members has a shielding device.
